(19) United States
(12) Patent Application Publication
(10) Pub. No.: US 2017/0066636 A1
(43) Pub. Date: Mar. 9, 2017

(54) Single Drive Three Pivot Forklift Truck Having Power Steering

(71) Applicant: Big Lift, LLC, Lombard, IL (US)

(72) Inventors: Yu Xiaoxian, Hangzhou (CN); Li Yang, Hangzhou (CN); Xu Linjie, Hangzhou (CN)

(21) Appl. No.: 14/976,243

(22) Filed: Dec. 21, 2015

(30) Foreign Application Priority Data
Sep. 8, 2015 (CN) 201520450919.0

(51) Int. Cl. B66F 9/075; B62D 5/04

(52) U.S. Cl. CPC B66F 9/07568; B62D 5/0463

(57) ABSTRACT

A single drive three pivot forklift truck having power steering includes a steering bridge connected to a forklift truck frame, a steering motor that drives rotation of the steering bridge, and at least one rear wheel that is connected to the steering bridge. The forklift truck also includes a first sensor that senses rotational position of a steering wheel, a second sensor that senses rotation of the steering motor, and a controller that receives signals from the first sensor and second sensor and controls the steering motor.

### CROSS-REFERENCE TO RELATED APPLICATION

This application claims priority to Chinese Patent Application No. 201520450919.0, filed Sep. 8, 2015, which is hereby incorporated by reference in its entirety.

### FIELD OF THE INVENTION

The disclosure relates to forklift trucks, and more particularly to a single drive three pivot forklift truck having power steering.

### BACKGROUND

Forklift trucks are industrial vehicles and may be of various wheeled types. Forklift trucks may be used for cargo loading and unloading, stacking and short distance transportation operations. The international standards organization ISO/TC110 refers to them as industrial vehicles, and forklift trucks commonly are used to transport large objects, usually using a motor that includes a fueled engine or a battery drive.

A three pivot forklift truck is a forklift truck that has the entire weight of the forklift truck essentially supported by three support points. For example, the three support points may be located at the points of contact with the ground of a pair of spaced apart front wheels, and a third point of contact with the ground may be located at the contact of at least one rear wheel that is at a middle rear position on the forklift truck frame or chassis. Compared to four pivot forklift trucks, a three pivot forklift truck has similar stability, but more flexibility or maneuverability in steering, especially when turning 360 degrees.

A traditional three pivot forklift truck is driven by dual drive motors, and uses applied hydraulic steering. The hydraulic steering has a pump that is driven by a pump motor to generate hydraulic pressure for the system. The pressure is output to a steering wheel diverter valve. Steering system pressures are determined by the rotational position of an operator steering wheel and are distributed to a horizontal steering master cylinder on a steering bridge. The cylinder on the steering bridge drives directional rotation of the wheels, so as to achieve steering of the forklift truck. However, the existence of the hydraulic steering system pressures causes the steering system to feel heavy or require such effort from an operator that it can easily make an operator tired. In addition, it requires power to maintain the system pressure, which causes large energy losses and consumption. Additionally, a hydraulic steering system has a potential risk for leakage of the hydraulic fluid.

### SUMMARY

The disclosure provides a single drive three pivot forklift truck having power steering which can improve over traditional forklift truck operation, convenience, energy consumption, and safety and stability of steering, when compared to using a hydraulic steering system.

In order to solve the technical problems, the single drive three pivot forklift truck having power steering of the present disclosure utilizes the following technical scheme. A single drive three pivot forklift truck having power steering comprises a forklift truck frame, a steering bridge connected to the forklift truck frame, at least one rear wheel rotatably connected to the steering bridge, a steering wheel rotatably mounted on the forklift truck frame, a steering gear mounted on the steering bridge, a shaft of a steering motor connected to an input gear that meshes with the steering gear, a first sensor that senses steering wheel rotational position, a second sensor that senses steering motor rotation, and a controller that receives signals from the first sensor and second sensor and controls the steering motor.

The first sensor senses the steering wheel rotational position and provides a first signal, and the controller receives the first signal and controls the steering motor based on that first signal, causing directional rotation of the steering bridge and at least one rear wheel, so as to achieve steering of the forklift truck. Meanwhile, the second sensor senses the steering motor rotation and provides a second signal, and the controller receives the second signal and can use the second signal to help control the steering motor rotation, to ensure accuracy and stability of the steering. In this way, the system is able to eliminate some of the parts that otherwise are needed with a hydraulic power steering system, such as a steering diverter valve, a steering master cylinder, and other hydraulic parts, which saves the cost of the parts, lowers the forklift truck weight, and avoids the risk of leakage of hydraulic fluid. In addition, the steering becomes much more accurate and there is a reduction in steering delay, while saving energy, and thereby extending the potential hours of operation. Also, it has the advantage of providing easier and more comfortable operation by presenting less resistance to steering wheel rotation, which permits an operator to work longer, with less fatigue.

In a preferred example, the first sensor is located under the steering wheel, and the second sensor is located at the end of the steering motor. It should be noted that sensor locations can make the detection or measurement by the sensors more accurate, which helps ensure the steering accuracy.

While at least one rear wheel is needed, the preferred example includes a pair of relatively closely spaced apart rear wheels that are centrally located near the rear of the forklift truck frame. The steering gear is connected on the steering bridge with bolts. Also included are a drive axle or transaxle, a gear box, a traction motor, and a pair of front wheels that are rotatably connected to the opposed ends of the drive axle. The gear box also is connected to the drive axle, and the traction motor causes rotation through the gear box and drive axle so as to drive the front wheels. The controller is connected to the traction motor by cables and it controls the traction motor to cause it to rotate. A battery is carried by the forklift truck frame and is connected to the controller to provide power to the controller. In comparison to an external power supply, this arrangement is much more convenient and easier to work with.

In the preferred example, the traction motor is connected to the gear box with bolts, and the gear box is connected to the middle of the drive axle. With a bolted connection, assembly of the gear box and traction motor becomes very convenient, and facilitates maintenance of the forklift truck.

The disclosure provides an advantageous technical effect by adopting the above technical scheme, wherein the power steering system comprises at least one sensor and a controller which can control the steering of the forklift truck, which realizes the power steering of the forklift truck and has the advantages of high steering accuracy, vehicle stability, lower weight of the forklift truck, a low likelihood of safety hazards, easy operation, longer operation time of the forklift truck, improved operator comfort, less operator fatigue, and reduced steering delay.

### BRIEF DESCRIPTION OF THE DRAWINGS

FIG. 1 is a schematic side view of an example forklift truck in accordance with the present disclosure; and

FIG. 2 is a schematic top view of the forklift truck of FIG. 1.

The components in the drawings are referred to as follows: forklift truck frame 1, steering bridge 2, rear wheels 3, steering motor 4, steering gear 5, input gear 6, first sensor 7, second sensor 8, controller 9, steering wheel 11, drive axle 12, gear box 13, traction motor 14, front wheels 15, and battery 16. A further detailed description of the drawings and examples is presented below.

### DETAILED DESCRIPTION OF THE PREFERRED EMBODIMENT

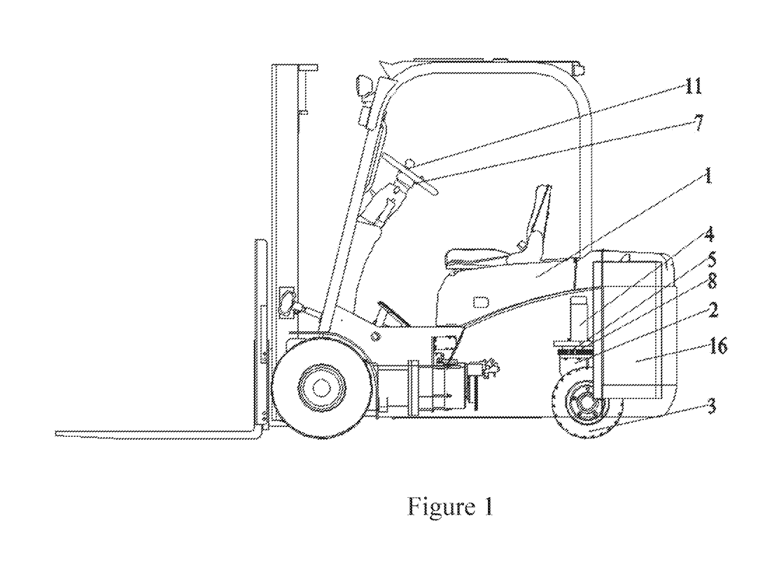

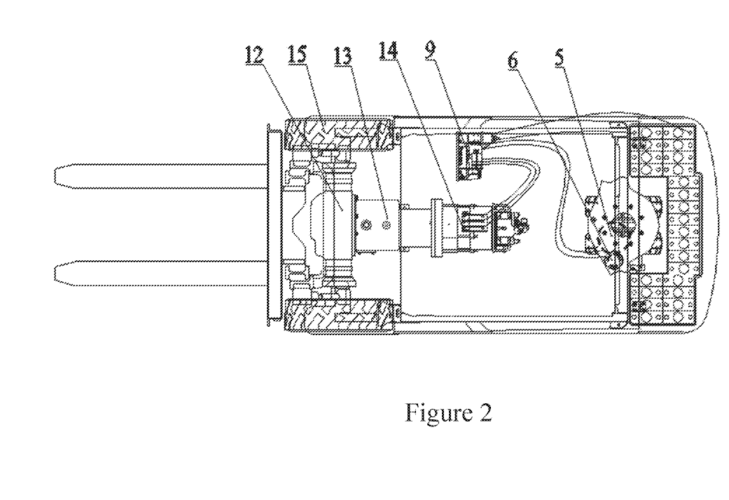

A single drive three pivot forklift truck having power steering is shown in FIGS. 1 and 2, and includes a forklift truck frame 1, a steering bridge 2 connected to the forklift truck frame, and at least one rear wheel 3 rotatably connected to the steering bridge 2. A steering wheel 11 is rotatably mounted on the forklift truck frame 1, a steering gear 5 is mounted on the steering bridge 2, and a shaft of a steering motor 4 is connected to an input gear 6 that meshes with the steering gear 5. Also included are a first sensor 7 that senses the rotational position of the steering wheel 11, a second sensor 8 that senses rotation of the steering motor 4, and a controller 9 that receives signals from the first sensor 7 and second sensor 8 and controls the steering motor 4. In this example, the first sensor 7 preferably is located under the steering wheel 11, and the second sensor 8 is located at an end of the steering motor 4.

The forklift truck further includes a drive axle 12, a gear box 13, a traction motor 14 and front wheels 15 rotatably connected to opposed ends of the drive axle 12. The gear box 13 is connected to the drive axle 12, and the traction motor 14 is connected to the gear box 13 with bolts, and causes rotation through the gear box 13 and drive axle 12 to drive the front wheels. The controller 9 and traction motor 14 are connected by cables, and the controller 9 controls rotation of the traction motor 14.

A battery 16 is carried by the forklift truck frame 1 and is connected to and provides power to the controller 9. The battery 16 provides power to the controller 9, and the controller 9 controls the rotation of the traction motor 14. In turn, the traction motor 14 causes rotation through the gear box 13, which causes rotation through the drive axle 12, which rotatably drives the front wheels 15, so as to realize forklift truck forward and rearward driving, while the rear wheels 3 of the present example are not drive wheels.

When the steering wheel 11 is being rotated, the first sensor 7 that senses rotational position of the steering wheel 11 sends a signal to the controller 9. The controller 9 receives the signal from the first sensor 7 and controls rotation of the steering motor 4, which causes rotation of the input gear 6, and in turn the input gear 6 meshes with and causes rotation of the steering gear 5. This causes directional rotation of the steering bridge 2 and the rear wheels 3 rotatably connected thereto, to achieve the purpose of steering. In addition, with rotation of the steering motor 4, the second sensor 8 starts to detect rotation of the steering motor 4, and may detect the steering motor speed, angle and/or other attributes, and transmits signals for such detected attributes to the controller 9. The controller 9 also controls the traction motor 14 according to the signals received from the second sensor 8, and uses the signals to make the steering more accurate and more stable.

It will be understood that the above example presents a preferred embodiment, but the patent is entitled to a range of equivalents and is directed to embodiments that may include modifications, as long as they fall within the coverage of the claims.

1. A single drive three pivot forklift truck having power steering comprising: a forklift truck frame, a steering bridge connected to the forklift truck frame, at least one rear wheel rotatably connected to the steering bridge, a steering wheel rotatably mounted on the forklift truck frame, a steering gear mounted on the steering bridge, a shaft of a steering motor connected to an input gear that meshes with the steering gear, a first sensor that senses steering wheel rotational position, a second sensor that senses steering motor rotation, and a controller that receives signals from the first sensor and second sensor and controls the steering motor.

2. The single drive three pivot forklift truck having power steering according to claim 1, wherein the first sensor is located under the steering wheel, and the second sensor is located at an end of the steering motor.

3. The single drive three pivot forklift truck having power steering according to claim 1, wherein the at least one rear wheel and the steering gear are connected to the steering bridge with bolts.

4. The single drive three pivot forklift truck having power steering according to claim 1, further comprising a drive axle, a gear box, a traction motor, and front wheels that are rotatably connected to opposed ends of the drive axle, and the gear box being connected to the drive axle, wherein the traction motor causes rotation through the gear box and drive axle so as to drive the front wheels, and the controller is connected to the traction motor with cables and controls rotation of the traction motor.

5. The single drive three pivot forklift truck having power steering according to claim 1, wherein the traction motor is connected to the gear box with bolts.

6. The single drive three pivot forklift truck having power steering according to claim 1, wherein a battery is carried by the truck frame and provides power to the controller.
